(19) United States
(12) Patent Application Publication
(10) Pub. No.: US 2015/0012317 A1
(43) Pub. Date: Jan. 8, 2015

(54) INFORMATION ANALYSIS SUPPORTING APPARATUS AND METHOD

(71) Applicant: FUJITSU LIMITED, Kawasaki-shi (JP)

(72) Inventor: Isamu Watanabe, Kawasaki (JP)

(21) Appl. No.: 14/496,154

(22) Filed: Sep. 25, 2014

Related U.S. Application Data
(63) Continuation of application No. PCT/JP2012/058444, filed on Mar. 29, 2012.

(51) Int. Cl. G06Q 10/06

(52) U.S. Cl. CPC G06Q 10/063
USPC 705/7.11

(57) ABSTRACT

An information analysis supporting apparatus includes a computer processor and a storage part. The storage part stores first data correlating data item names of analysis object data and standardized data item names and second data correlating the standardized data item names and information related to analysis processes. The storage part stores instructions that, when executed by the computer processor, cause the information analysis supporting apparatus to search, in response to inputting of the analysis object data, the first data using the data item names of the input analysis object data and extract the standardized data item names, search the second data using the extracted standardized data item names and extract the information related to the analysis processes, and cause a presentation part to present the extracted information related to the analysis processes.

### CROSS-REFERENCE TO RELATED APPLICATION

This application is a continuation application of International Application PCT/JP2012/058444, filed on Mar. 29, 2012 and designating U.S., the entire contents of which are incorporated herein by reference.

### FIELD

A certain aspect of the embodiments discussed herein is related to information analysis supporting apparatuses and methods.

### BACKGROUND

Techniques such as analyzing data trends and making future forecasts by analyzing a variety of data using computers have been widely used. In such techniques, it is important to suitably select the purpose and method of analysis (hereinafter, “analysis process”). Examples of purposes of analysis include an analysis of attributes of commercial products that affect selection of commercial products, a structural analysis of brand preference, and sales forecasting on a shop-by-shop basis. Examples of methods of analysis include factor analysis, correspondence analysis, and cluster analysis.

A deliverable management apparatus is known that stores deliverables (software) and development process knowledge that are related to each other as metadata and supports the creation and editing of development process knowledge based on input development process execution information or development process knowledge. (See, for example, Japanese Laid-Open Patent Publication No. 2008-310461.)

### SUMMARY

According to an aspect of the embodiments, an information analysis supporting apparatus includes a computer processor and a storage part. The storage part stores first data correlating data item names of analysis object data and standardized data item names and second data correlating the standardized data item names and information related to analysis processes. The storage part stores instructions that, when executed by the computer processor, cause the information analysis supporting apparatus to search, in response to inputting of the analysis object data, the first data using the data item names of the input analysis object data and extract the standardized data item names, search the second data using the extracted standardized data item names and extract the information related to the analysis processes, and cause a presentation part to present the extracted information related to the analysis processes.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a flowchart created in the process of analyzing a subject of analysis;

FIG. 2 is a diagram illustrating a hardware configuration of an information analysis supporting apparatus according to a first embodiment;

FIG. 3 is a diagram illustrating a functional configuration of the information analysis supporting apparatus according to the first embodiment;

FIG. 4 is a diagram illustrating a data specifying screen displayed by a display unit;

FIG. 5 is a flowchart illustrating a flow of an analysis template creating process;

FIG. 6 is a diagram illustrating an analysis template creating screen displayed by the display unit;

FIG. 7 illustrates data stored as a meaning type determination table;

FIG. 8 illustrates data stored as an analysis template correspondence table;

FIG. 9 is a flowchart illustrating a flow of a process executed by an analysis template retrieving part;

FIG. 10 is a flowchart illustrating a flow of a process executed by the analysis template retrieving part;

FIG. 11 is a flowchart illustrating a flow of a process executed by the analysis template retrieving part;

FIG. 12 is a diagram illustrating an initial screen displayed by the display unit;

FIG. 13 is a diagram illustrating a retrieval result display screen displayed by the display unit;

FIG. 14 is a diagram illustrating a retrieval result display screen displayed by the display unit;

FIG. 15 is a flowchart illustrating another flow of a process executed by the analysis template retrieving part;

FIG. 16 is a diagram illustrating a data structure of the meaning type determination table that an information analysis supporting apparatus of a second embodiment stores in a secondary storage device; and

FIG. 17 is a flowchart illustrating part of a flow of a process executed by the analysis template retrieving part according to the second embodiment.

### DESCRIPTION OF EMBODIMENTS

The known deliverable management apparatus as described above does not support an analysis of information, and therefore, is not capable of causing a user to select a suitable purpose or method of information analysis.

In the field of information analysis, it is possible to improve the efficiency of a process of analyzing a new subject of analysis if it is possible to store scripts and flowcharts created in the process of analyzing a subject of analysis and effectively reuse the stored analysis processes (scripts and flowcharts).

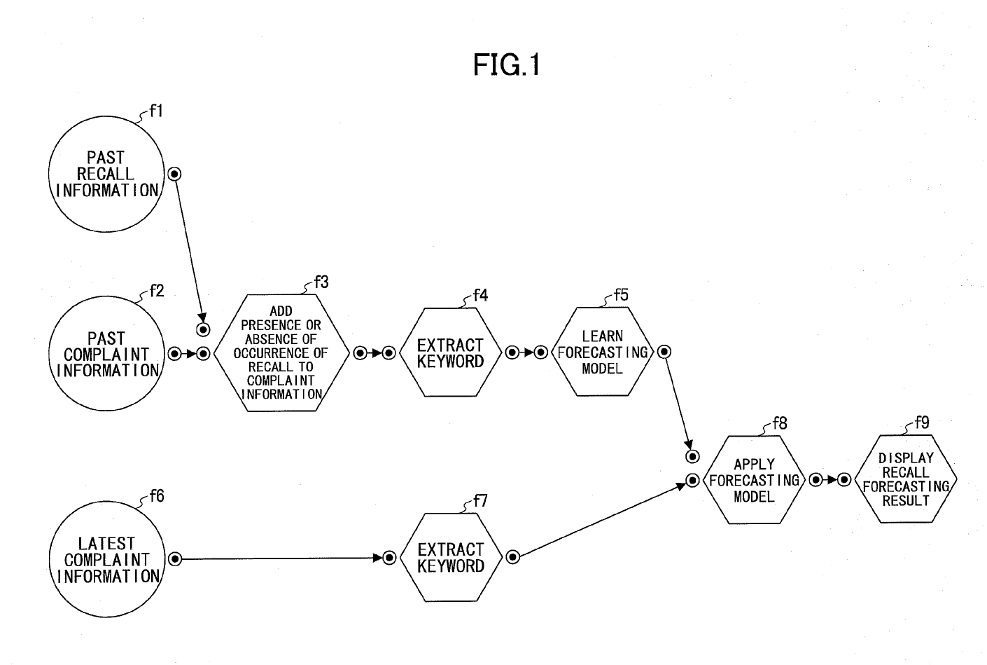

FIG. 1 is a flowchart created in the process of analyzing a subject of analysis. The flowchart represents an analysis process of forecasting a recall by creating a forecasting model that forecasts a recall from past recall and complaint information and applying the created forecast model to the latest complaint information. In FIG. 1, analysis components f1 through f9 represent specific processes.

The analysis component f1 indicates the process of reading past recall information. The analysis component f2 indicates the process of reading past complaint information. The analysis component f3 indicates the process of adding the presence or absence of the occurrence of a recall to the complaint information. For example, the process of adding, to the complaint information, information as to whether a product was recalled within a predetermined period (for example, six months) from the date of a complaint about the product, using the information of a product name and a date included in both the recall information and the complaint information, is executed at the analysis component f3.

The analysis component f4 indicates the process of extracting a keyword from the text information of the contents of a complaint of the past complaint information to which the past recall information is added, using, for example, a morphological analysis technique. The analysis component f5 indicates the process of learning a forecasting model that learns, using, for example, a machine learning technique, a classification rule that forecasts the presence or absence of the occurrence of a recall from a keyword, using the keyword obtained at the analysis component f4 and the information of the presence or absence of the occurrence of a recall obtained at the analysis component f3. The keyword is treated as an explanatory variable, and the presence or absence of the occurrence of a recall is treated as a response variable.

The analysis component f6 indicates the process of reading the latest complaint information (for example, of the last one month). The analysis component f7 indicates the process of extracting a keyword from the text information of the read latest complaint information. The analysis component f8 indicates the process of applying the forecasting model. To be more specific, the process of forecasting whether a recall will occur with respect to the latest complaint information, using the forecasting model obtained as a result of the process of the analysis component f5 and the keyword obtained at the analysis component f7, is executed at the analysis component f8. The analysis component f9 indicates the process of displaying the result of forecasting whether a recall will occur obtained at the analysis component f8.

Thus, the analysis process is represented by, for example, a group of analysis components and a flowchart, and it is possible for a user with a certain level of analysis knowledge to proceed with a complicated analysis process with relative ease with the aid of a computer. In this case, it is also possible to improve efficiency by storing and reusing scripts and flowcharts created in the process of analyzing past subjects of analysis.

In the case of a user without an advanced knowledge of analysis, however, it may be impossible to understand the contents of scripts or flowcharts, so that it may be impossible to find an analysis process that is suitable for a subject of analysis. As the number of stored analysis processes increases, it becomes more difficult to retrieve a suitable analysis process, thus making this problem more serious.

According to an aspect of the invention, a user is caused to select a suitable analysis process in accordance with the contents of data to be analyzed.

Preferred embodiments of the present invention will be explained with reference to accompanying drawings.

### [a] First Embodiment

A description is given below of an information analysis supporting apparatus and method according to a first embodiment.

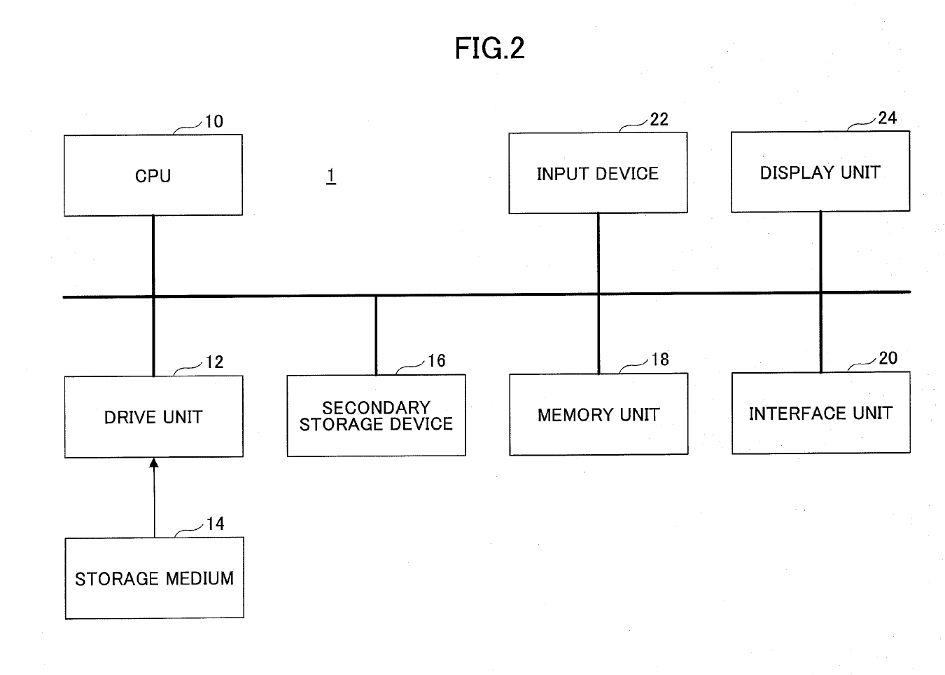

FIG. 2 is a diagram illustrating a hardware configuration of an information analysis supporting apparatus according to the first embodiment. The information analysis supporting apparatus 1 includes, for example, a central processing unit (CPU) 10, a drive unit 12, a secondary storage device 16, a memory unit 18, an interface unit 20, an input device 22, and a display unit 24, all of which are interconnected by a bus or a serial line.

The CPU 10 is, for example, a processor as a processing unit that includes a program counter, a command decoder, various kinds of computing units, a load-store unit (LSU), and a general-purpose register.

The drive unit 12 reads programs and data from a storage medium 14. When the storage medium 14 on which a program is recorded is loaded into the drive unit 12, the program is installed in the secondary storage device 16 via the drive unit 12. The storage medium 14 is a portable storage medium. Examples of the storage medium 14 include a compact disk (CD), a digital versatile disk (DVD), and a universal serial bus (USB) memory. Examples of the secondary storage device 16 include a hard disk drive (HDD) and a flash memory.

Instead of using the storage medium 14 as described above, a program may alternatively be installed in the secondary storage device 16 by being downloaded from another computer via a network by the interface unit 20. The network may be, for example, the Internet, a local area network (LAN), or a radio network. The program may also be pre-stored in the secondary storage device 16 or a read-only memory (ROM) at the time of shipment of the information analysis supporting apparatus 1.

It is possible for an information processor configured as illustrated in FIG. 2 to serve as the information analysis supporting apparatus 1 of this embodiment by the CPU 10 executing the program thus installed or pre-stored.

Examples of the memory unit 18 include a random access memory (RAM), an electrically erasable and programmable ROM (EEPROM), and a flash memory. The interface unit 20 controls connection to the network.

The input device 22 may include one or more of, for example, a keyboard, a mouse, buttons, a touchpad, a touchscreen, and a microphone. The display unit 24 includes, for example, a liquid crystal display (LCD) or a cathode ray tube (CRT). The information analysis supporting apparatus 1 may further include other kinds of output devices than the display unit 24, such as a printer and a loudspeaker.

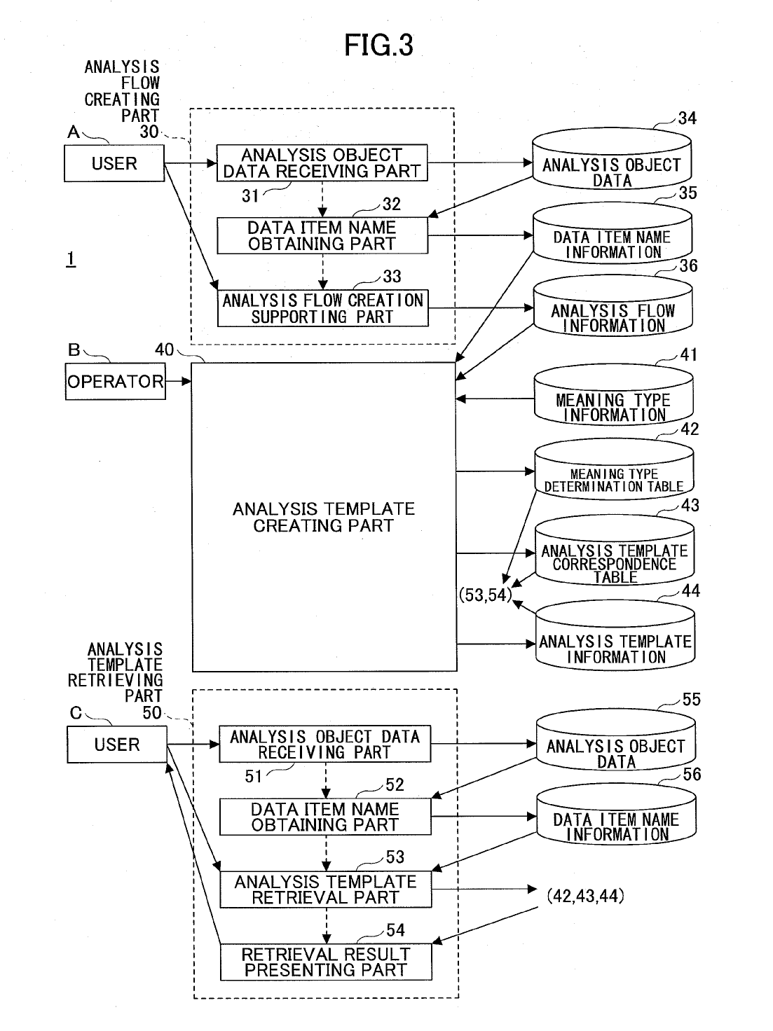

FIG. 3 is a diagram illustrating a functional configuration of the information analysis supporting apparatus 1 according to the first embodiment. The information analysis supporting apparatus 1 includes an analysis flow creating part 30, an analysis template creating part 40, and an analysis template retrieving part 50 as function blocks that function as a result of the execution of a program stored in the secondary storage device 16 by the CPU 10.

A description is given of an analysis flow creating process.

Referring to FIG. 3, the analysis flow creating part 30 helps a user A create a new analysis flow, and generates data item name information 35 based on the information obtained in the process of creating the new analysis flow. The analysis flow created by the user A is recognized as a combination of data to be analyzed (analysis object data) and an analysis process, and is used in the below-described analysis template creating process and analysis template retrieving process.

The analysis flow creating part 30 includes an analysis object data receiving part 31, a data item name obtaining part 32, and an analysis flow creation supporting part 33.

The analysis object data receiving part 31 receives data input by the user A, and stores the input data in, for example, the memory unit 18 (FIG. 2) as analysis object data 34.

The data item name obtaining part 32 extracts data item names from the analysis object data 34, and stores the extracted data item names in, for example, the secondary storage device 16 (FIG. 2) or the memory unit 18 as the data item name information 35.

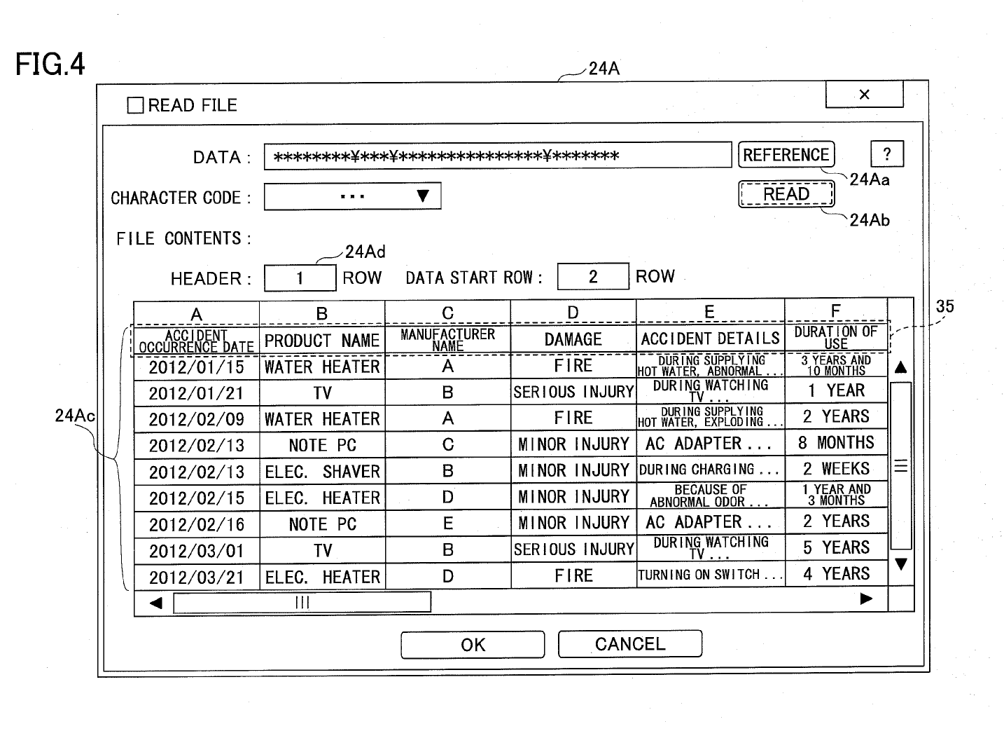

FIG. 4 is a diagram illustrating a data specifying screen 24A displayed by the display unit 24 when the user A specifies the analysis object data 34 and the data item name obtaining part 32 extracts a data item name. When the user A clicks a REFERENCE button 24Aa on the data specifying screen 24A, for example, a list of the analysis object data 34 is displayed. When the user A selects specific analysis object data 34 and clicks a READ button 24Ab, the contents of the selected analysis object data 34 are displayed in a display area 24Ac. In the case illustrated in FIG. 4, a header, that is, data item names are specified as the first row in a window 24Ad. Therefore, the first line of the analysis object data 34 is selected and stored as the data item name information 35 by the data item name obtaining part 32.

The data item name obtaining part 32 may cause the user A to enter the row number (or column number) of data item names as illustrated in FIG. 4 or may estimate which data are data item names based on a rule according to the format of input data. For example, when data belonging to the same data item are arranged in a column direction, the data item name obtaining part 32 extracts data arranged at a row preceding a data start row in the analysis object data 34 as data item names. On the other hand, when data belonging to the same data item are arranged in a row direction, the data item name obtaining part 32 extracts data arranged at a column preceding a data start column in the analysis object data 34 as data item names.

The analysis flow creation supporting part 33 creates a flowchart connecting analysis components as illustrated by way of example in FIG. 1 in accordance with the user A's operations, for example, and causes the created flowchart to be displayed on the display unit 24. The analysis flow creation supporting part 33 stores information on the created analysis flow in, for example, the secondary storage device 16 or the memory unit 18 as analysis flow information 36. The analysis flow information 36 is information where the analysis object data 34 (and the data item name information 35) are correlated with an analysis process included in the analysis flow.

A description is given of an analysis template creating process.

Referring to FIG. 3, the analysis template creating part 40 executes a process for helping a user who sets up the information analysis supporting apparatus 1 (here referred to as “operator B”) correlate the analysis flow information 36 with meaning type information 41 prepared in advance.

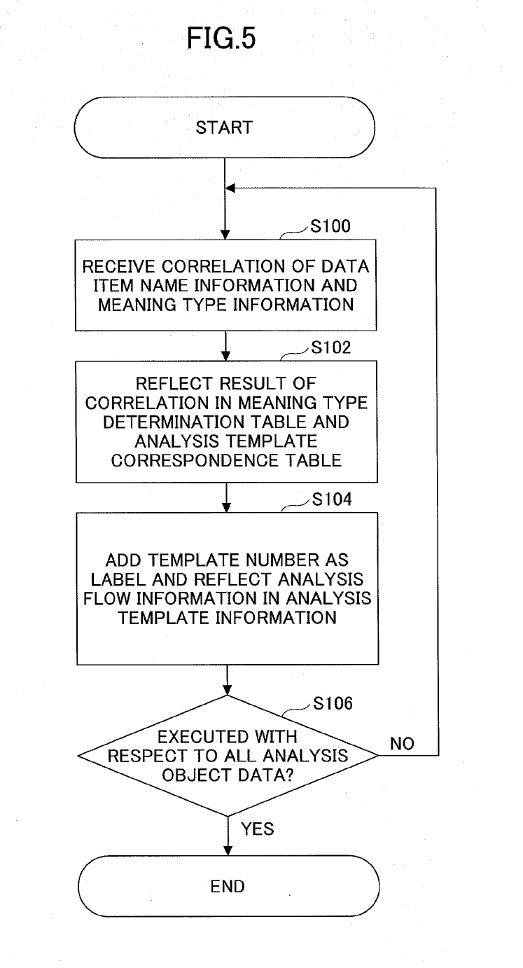

FIG. 5 is a flowchart illustrating a flow of the analysis template creating process. This flowchart is started by, for example, the operator B performing a start operation at any time.

First, at step S100, the analysis template creating part 40 receives the correlation of the data item name information 35 with respect to the analysis object data 34 to be processed this time and the meaning type information 41 by the operator B.

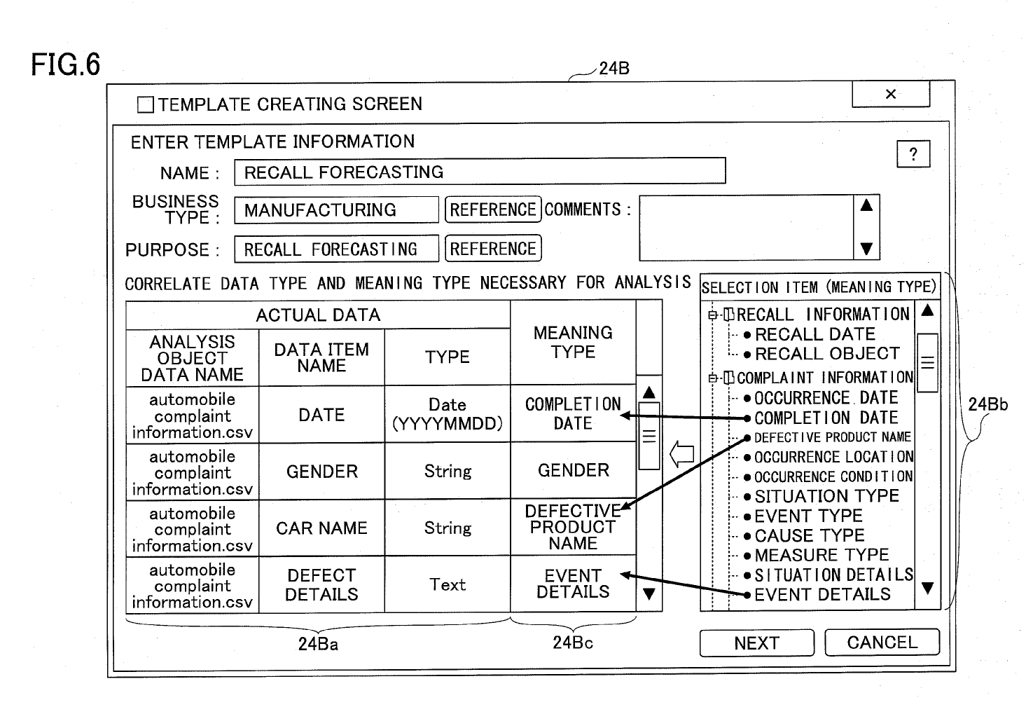

FIG. 6 is a diagram illustrating an analysis template creating screen 24B displayed by the display unit 24 when the operator B correlates the data item name information 35 with respect to the analysis object data 34 to be processed this time with the meaning type information 41. On the analysis template creating screen 24B, an analysis object data name, a data item name, and a type (data format) are displayed in a display area 24Ba. Furthermore, meaning types as selection items are enumerated in a display area 24Bb. The operator B drags a meaning type in the display area 24Bb and drops the meaning type to a position corresponding to a data item name in a display area 24Bc, so that the data item name and the meaning type are correlated.

Here, the meaning type is a preset standardized data item name. For example, letting “completion date” be a meaning type, various data item names such as “completion date,” “date,” and “year, month and day of completion” may be used to mean the “completion date” depending on the analysis object data 34. Therefore, according to the information analysis supporting apparatus 1 of this embodiment, a group of data item names that are highly likely to be expressed as different data item names in spite of being the same data item name in substance are treated as the same data item name, using a standardized data item name as a representative name.

With respect to each data item name included in the data item name information 35, the operator B, at her/his discretion, determines a meaning type that is of the same type as the data item name, and correlates the meaning type with the data item name. Referring to FIG. 3, the meaning type information 41, a meaning type determination table 42, an analysis template correspondence table 43, and analysis template information 44 are information stored in, for example, the secondary storage device 16.

Referring back to FIG. 5, next, at step S102, the analysis template creating part 40 reflects the result of the correlation at step S100 in the meaning type determination table 42 and the analysis template correspondence table 43.

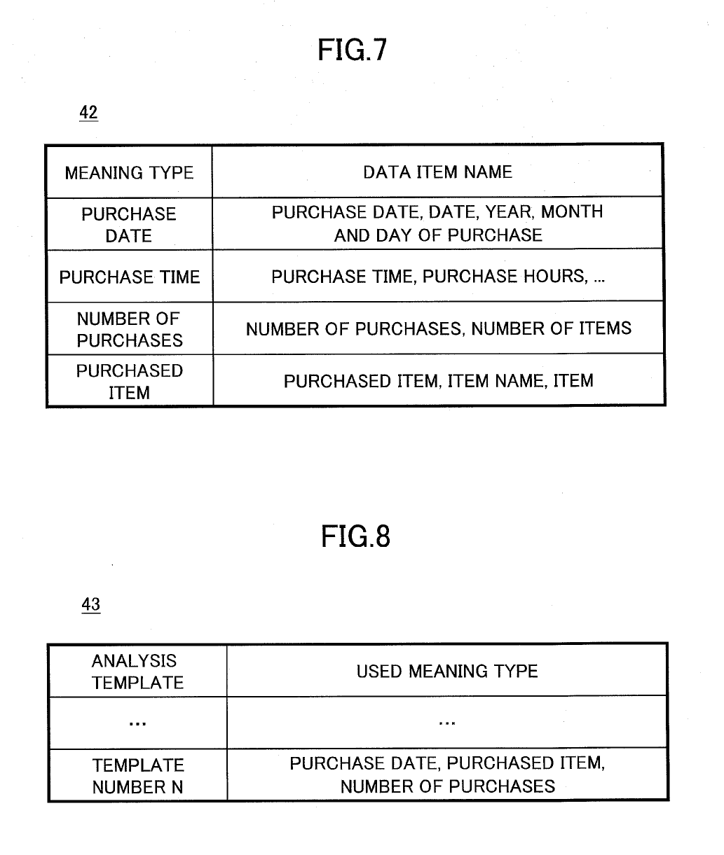

FIG. 7 illustrates data stored as the meaning type determination table 42. Referring to FIG. 7, the meaning type determination table 42 is information where multiple data item names are correlated with a single meaning type.

FIG. 8 illustrates data stored as the analysis template correspondence table 43. Referring to FIG. 8, the analysis template correspondence table 43 is data where a meaning type that replaces data item names of the analysis object data 34 is correlated with a template number that serves as a label of the below-described analysis template information 44.

Next, at step S104 of FIG. 5, the analysis template creating part 40 reflects data where a template number is added as a label to information related to the analysis flow associated with the analysis object data 34 in the analysis template information 44.

Then, at step S106, the analysis template creating part 40 determines whether the process of steps S100 through S104 has been executed with respect to all the analysis object data 34. If the process of steps S100 through S104 has not been executed with respect to all the analysis object data 34 (NO at step S106), the process returns to step S100. If the process of steps S100 through S104 has been executed with respect to all the analysis object data 34 (YES at step S106), the process of this flowchart ends.

A description is given of an analysis template retrieving process.

The meaning type determination table 42, the analysis template correspondence table 43, and the analysis template information 44 are updated as a result of the execution of the analysis flow creating process and the analysis template creating process. When the analysis template correspondence table 43 and the analysis template information 44 are combined, the combination becomes data where meaning types (standardized data item names) and information related to an analysis process suitable for the analysis of the analysis object data 34 whose contents are indicated by the meaning types are correlated.

Accordingly, when new analysis object data 55 are input by a user C (FIG. 3), by converting data item names included in the new analysis object data into meaning types using the meaning type determination table 42, it is possible to obtain information related to an analysis process suitable for the analysis of the new analysis object data 55 from the meaning types. The analysis template retrieving part 50 obtains information related to an analysis process suitable for the analysis of the new analysis object data 55 using the meaning type determination table 42, the analysis template correspondence table 43, and the analysis template information 44 that are prepared in advance, and presents the user C with the obtained information. Referring to FIG. 3, the analysis template retrieving part 50 includes an analysis object data receiving part 51, a data item name obtaining part 52, an analysis template retrieval part 53, and a retrieval result presenting part 54.

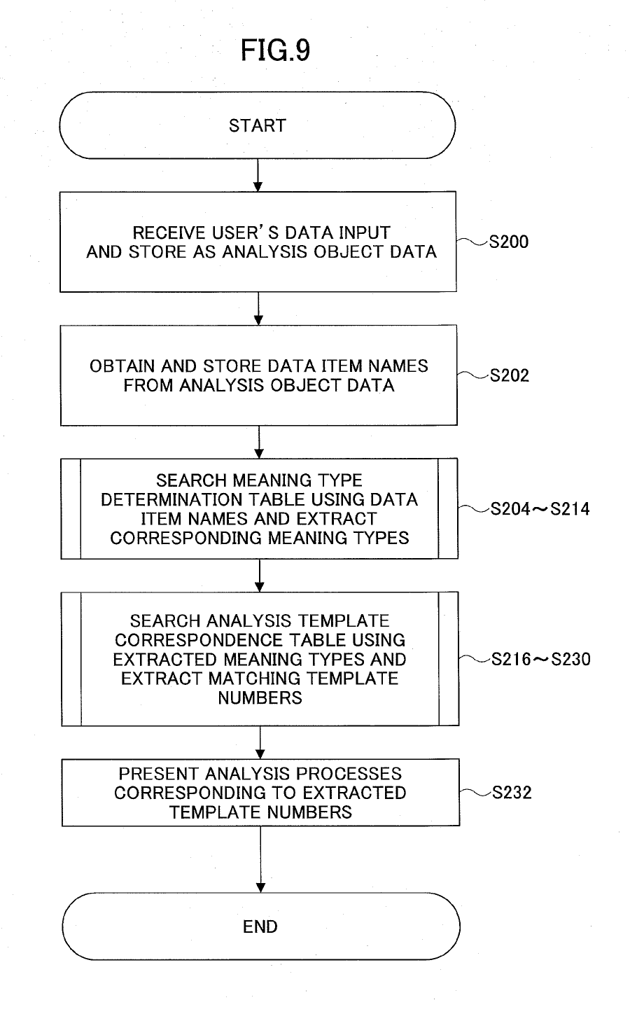

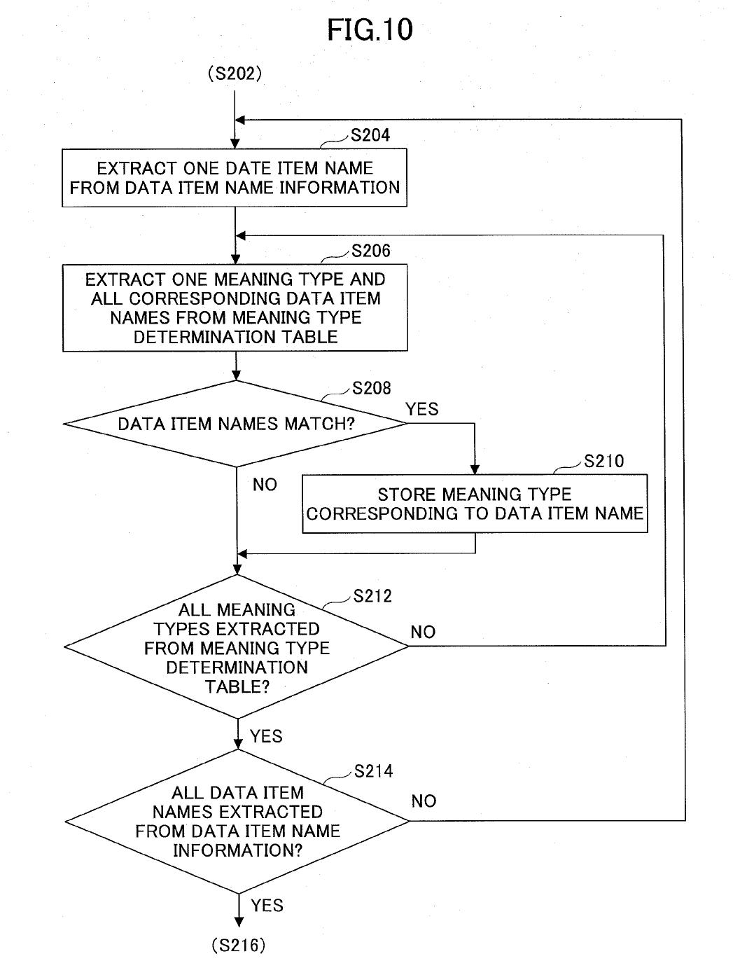

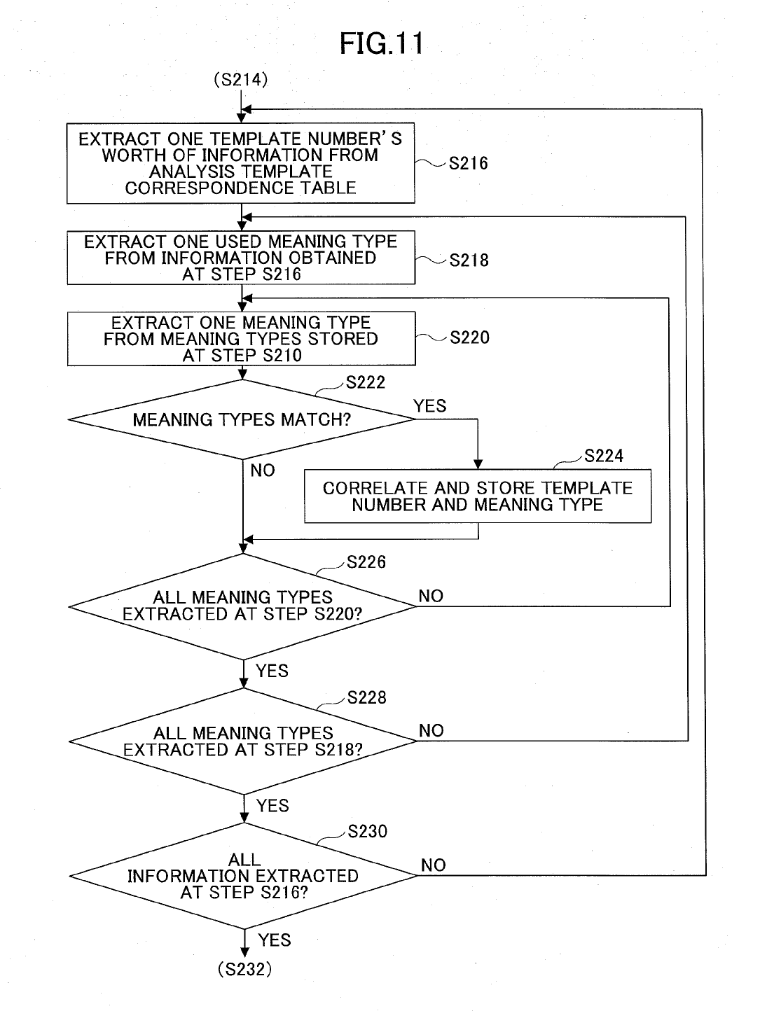

FIG. 9, FIG. 10 and FIG. 11 are flowcharts illustrating a flow of a process executed by the analysis template retrieving part 50.

First, at step S200 of FIG. 9, the analysis object data receiving part 51 receives data input by the user C, and stores the input data in, for example, the memory unit 18 (FIG. 2) as the analysis object data 55. Here, the user C may be the same as or different from the user A.

Next, at step S202, the data item name obtaining part 52 extracts data item names from the analysis object data 55, and stores the extracted data item names in, for example, the secondary storage device 16 (FIG. 2) or the memory unit 18 as data item name information 56. The process by the data item name obtaining part 52 may be the same as the process by the data item name obtaining part 32.

Next, at step S204 through S214, the analysis template retrieval part 53 searches the meaning type determination table 42 using the data item names extracted at step S202, and extracts corresponding meaning types.

A description is given, with reference to FIG. 10, of the process of step S204 through S214. First, at step S204, the analysis template retrieval part 53 extracts one data item name from the data item name information 56.

Next, at step S 206, the analysis template retrieval part 53 extracts one meaning type and all data item names corresponding to the one meaning type from the meaning type determination table 42.

Next, at step S208, the analysis template retrieval part 53 determines whether the data item name extracted at step S204 matches one of the data item names extracted at step S206. The analysis template retrieval part 53 may determine that there is a “match” only when the data item names completely match or may determine that there is a “match” when the data item names partially match. A partial match between data item names is allowable because, for example, when “year, month and day of purchase” is stored in the meaning type determination table 42, no substantial problem is caused by determining that “month and day of purchase” matches “year, month and day of purchase.” In the case of allowing a partial match, the analysis template retrieval part 53 may, for example, give weight to each word constituting a data item name in advance and determine whether a difference is within an allowable range.

If the data item name extracted at step S204 matches one of the data item names extracted at step S206 (YES at step S208), at step S210, the analysis template retrieval part 53 stores a meaning type corresponding to the data item name in, for example, the memory unit 18, and the process proceeds to step S212.

If the data item name extracted at step S204 does not match any of the data item names extracted at step S206 (NO at step S208), the process proceeds to step S212.

At step S212, the analysis template retrieval part 53 determines whether all meaning types and all corresponding data item names have been extracted from the meaning type determination table 42. If all meaning types and all corresponding data item names have not been extracted from the meaning type determination table 42 (NO at step S212), the process returns to step S206 and the analysis template retrieval part 53 extracts the next meaning type (and all corresponding data item names).

If all meaning types and all corresponding data item names have been extracted from the meaning type determination table 42 (YES at step S212), at step S214, the analysis template retrieval part 53 determines whether all data item names have been extracted from the data item name information 56. If all data item names have not been extracted from the data item name information 56 (NO at step S214), the process returns to step S204, and the analysis template retrieval part 53 extracts the next data item name.

If all data item names have been extracted from the data item name information 56 (YES at step S214), the process proceeds to step S216 (FIG. 9) and the analysis template retrieval part 53 executes a process.

When the process of steps S204 through S214 ends, at steps S216 through S230, the analysis template retrieval part 53 searches the analysis template correspondence table 43 using the extracted meaning types (the meaning types stored in the memory unit 18), and extracts a template number that matches the extracted meaning types.

A description is given, with reference to FIG. 11, of the process of steps S216 through S230. First, at step S216, the analysis template retrieval part 53 extracts one template number's worth of information from the analysis template correspondence table 43.

Next, at step S218, the analysis template retrieval part 53 extracts one “used meaning type” from the information obtained at step S216.

Next, at step S220, the analysis template retrieval part 53 extracts one of the meaning types stored at step S210.

Then, at step S222, the analysis template retrieval part 53 determines whether the meaning types extracted at steps S218 and S220 match. If the meaning types match (YES at step S222), at step S224, the analysis template retrieval part 53 correlates the meaning type with the template number, and stores the correlated meaning type and template number in, for example, the memory unit 18, and the process proceeds to step S226.

If the meaning types do not match (NO at step S222), the process proceeds to step S226.

At step S226, the analysis template retrieval part 53 determines whether all the meaning types have been extracted at step S220. If all the meaning types have not been extracted at step S220 (NO at step S226), the process returns to step S220, and the analysis template retrieval part 53 extracts the next meaning type.

If all the meaning types have been extracted at step S220 (YES at step S226), at step S228, the analysis template retrieval part 53 determines whether all “used meaning types” have been extracted at step S218. If all “used meaning types” have not been extracted at step S218 (NO at step S228), the process returns to step S218, and the analysis template retrieval part 53 extracts the next “used meaning type.”

If all “used meaning types” have been extracted at step S218 (YES at step S228), at step S230, the analysis template retrieval part 53 determines whether all information has been extracted at step S216. If all information has not been extracted at step S216 (NO at step S230), the process returns to step S216, and the analysis template retrieval part 53 extracts one template number's worth of information of the next template number.

If all information has been extracted at step S216 (YES at step S230), the process proceeds to step S232 (FIG. 9), and the retrieval result presenting part 54 executes a process.

At step S232, the retrieval result presenting part 54 presents the user C with the template numbers stored at step S224, the meaning types correlated with the template numbers, and the analysis processes correlated with the template numbers, using the display unit 24.

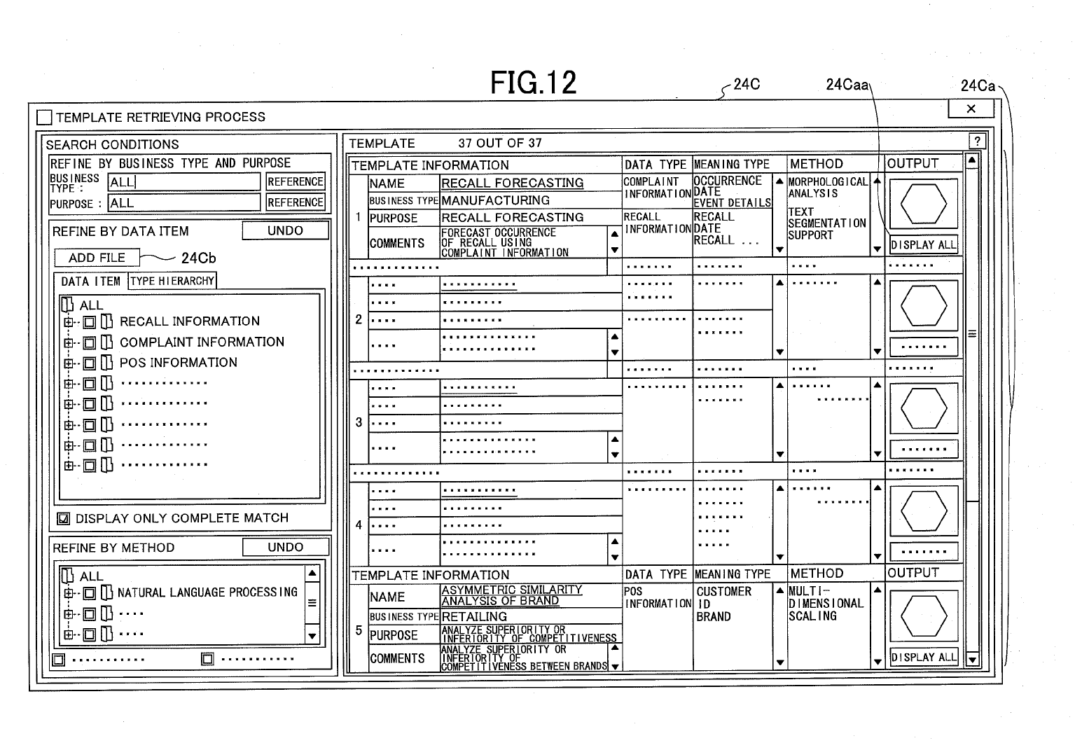

A description is given of a display screen displayed by the display unit 24 when the analysis template retrieving process is executed. FIG. 12 is a diagram illustrating an initial screen 24C displayed by the display unit 24 when the analysis template retrieving process is started. All template information included in the analysis template information 44 stored at the time is displayed in a main display part 24Ca of the initial screen 24C. A number at the left end of each item of the template information indicates a template number. Furthermore, with respect to each item of the template information, one or more “meaning types” and one or more “methods” correlated with the item are displayed, and when a DISPLAY ALL button 24Caa in an output column is clicked, a flowchart corresponding to the item (template information) is displayed.

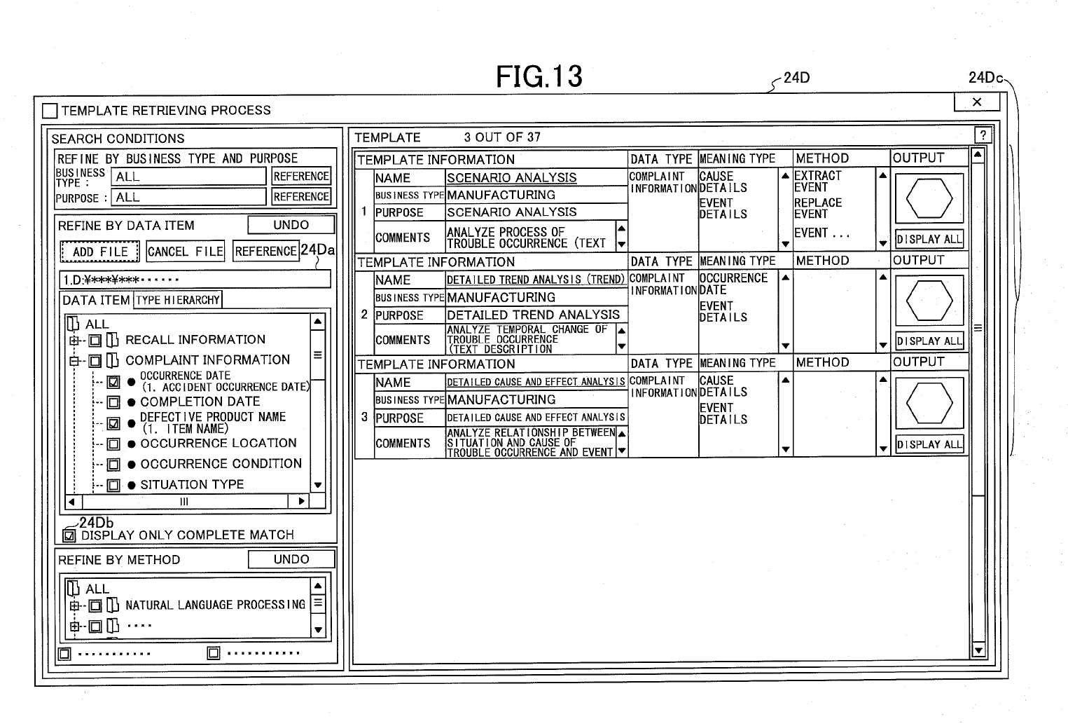

FIG. 13 is a diagram illustrating a retrieval result display screen 24D where analysis object data are selected and template information corresponding to the selected analysis object data is displayed. When an ADD FILE button 24Cb is clicked on the initial screen 24C of FIG. 12, a list of analysis object data is displayed. When the user C selects analysis object data and confirms the selection, the analysis object data are displayed in a window 24Da, and the process illustrated in FIGS. 9 through 11 is executed, so that retrieval results are displayed in a main display part 24Dc.

Referring to FIG. 13, because a check box 24Db (DISPLAY ONLY COMPLETE MATCH) is checked by the user C, only template information with respect to which all the meaning types stored in the analysis template correspondence table 43 are included in the meaning types extracted from the analysis object data is displayed in the main display part 24Dc.

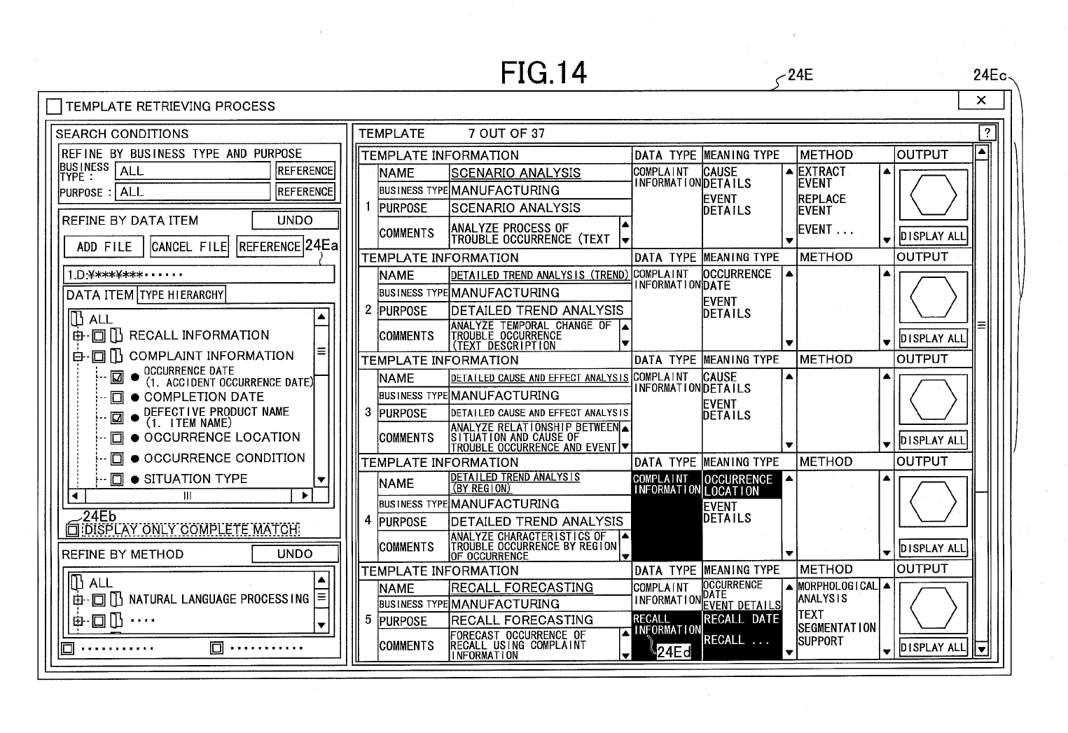

FIG. 14 is a diagram illustrating a retrieval result display screen 24E on which corresponding template information is displayed when analysis object data are selected and a search (retrieval) is performed with a condition different from the condition in the case illustrated in FIG. 13. FIG. 14 illustrates retrieval results in the case where a check box 24Eb (DISPLAY ONLY COMPLETE MATCH) is not checked by the user C. In this case, template information with respect to which only some of the meaning types stored in the analysis template correspondence table 43 are included in the meaning types extracted from the analysis object data is also displayed on the retrieval result display screen 24E. Of the meaning types stored in the analysis template correspondence table 43, those missing from the meaning types extracted from the analysis object data, that is, information not included in the meaning types extracted from the analysis object data (information 24Ed in FIG. 14), is displayed in a different manner, for example, in a different color, so as to make it possible for the user C to recognize the missing information. As a result, it is possible for the user C to understand data items to be added to the analysis object data in order to make it possible to properly execute the analysis process indicated by the corresponding template information. Accordingly, it is possible for the information analysis supporting apparatus 1 of this embodiment to properly support the analysis of information by the user C.

It is possible for the above-described information analysis supporting apparatus 1 of this embodiment to let a user select an appropriate analysis process in accordance with the contents of analysis object data.

An analysis process is substantially composed of analysis object data, a method of analysis, and a purpose of analysis. Therefore, methods such as performing a search by narrowing down (reducing the number of) analysis processes by a purpose of analysis, a business type, and a business operation, performing a search by narrowing down analysis processes by a method of analysis, and performing a search by narrowing down analysis processes by analysis object data are possible.

The search method that narrows down analysis processes by a purpose of analysis, a business type, and a business operation is not applicable if the purpose of analysis is not clarified. Furthermore, the search method that narrows down analysis processes by a method of analysis requires a user who performs an analysis to possess a high level of knowledge about methods of analysis.

It is possible to execute the search method that narrows down analysis processes by analysis object data if it is possible to prepare at least analysis object data. As described above, however, the analysis object data may be given various data item names. Therefore, it may be difficult to perform a search (retrieval) using the data item names of the analysis object data as they are.

On the other hand, the information analysis supporting apparatus 1 of this embodiment retains, in the form of a standardized meaning type, a group of data item names that are highly likely to be expressed as different data item names in spite of being the same data item name in substance. As a result, it is possible for the information analysis supporting apparatus 1 of this embodiment to solve a problem in that the retrieval of an analysis process is made difficult by a difference between data item names. Accordingly, it is possible for the information analysis supporting apparatus 1 of this embodiment to let a user who performs an analysis to select an appropriate analysis process in accordance with the contents of analysis object data even when the user does not possess a high level of knowledge about methods of analysis.

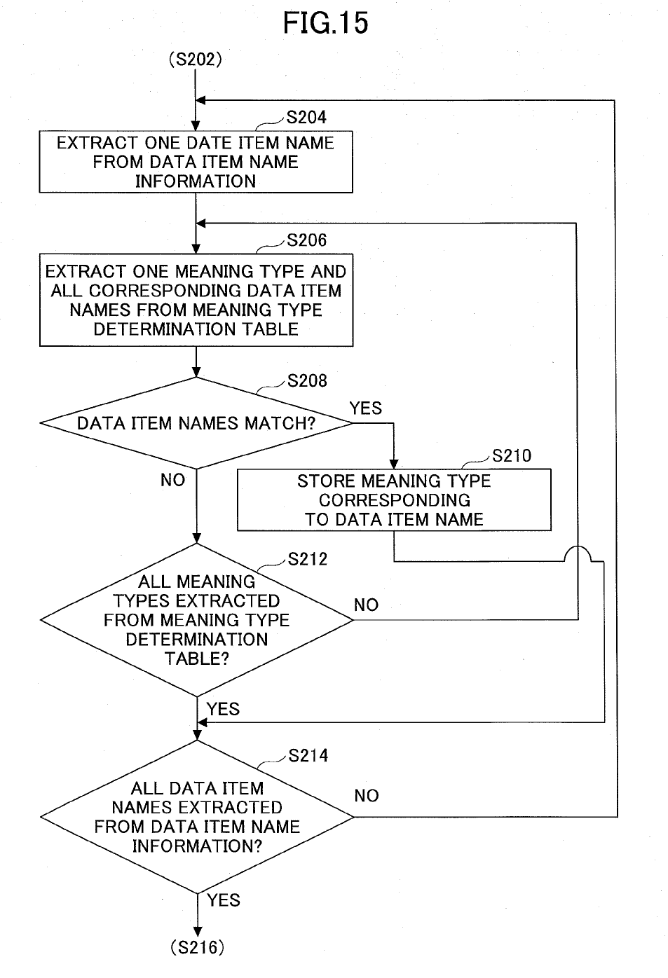

In the process illustrated in FIG. 10, in extracting a corresponding meaning type using a data item name, a search with respect to the data item name may be suspended once a corresponding meaning type is extracted. FIG. 15 is a flowchart illustrating another flow of a process executed by the analysis template retrieving part 50. If the data item name extracted at step S204 matches one of the data item names extracted at step S206 (YES at step S208), at step S210, the analysis template retrieval part 53 stores a meaning type corresponding to the data item name in, for example, the memory unit 18, and the process proceeds to step S214. In this case, it is preferable to properly predetermine search order of meaning types so that, for example, meaning types of high hit ratios are ranked high in the search order.

### [b] Second Embodiment

A description is given below of an information analysis supporting apparatus and method according to a second embodiment. An information analysis supporting apparatus 2 of the second embodiment is different from the information analysis supporting apparatus 1 of the first embodiment in the structure of the meaning type information 41 (FIG. 3) and the handling of meaning types.

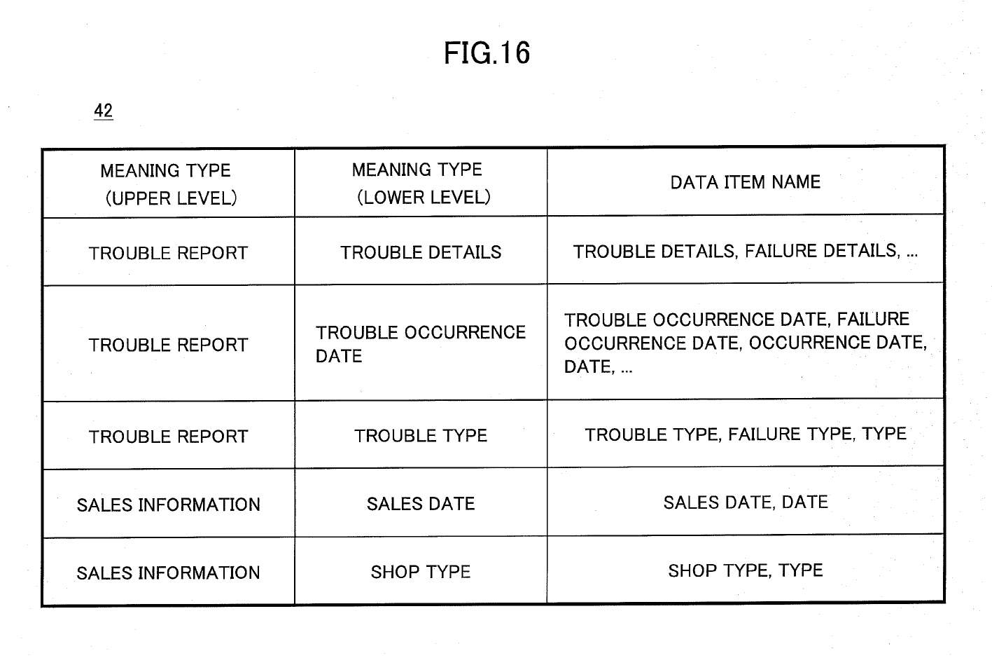

FIG. 16 is a diagram illustrating a data structure of the meaning type determination table 42 that the information analysis supporting apparatus 2 of the second embodiment stores in the secondary storage device 16 (FIG. 2). Referring to FIG. 16, according to the second embodiment, meaning types are hierarchized, and multiple meaning types are grouped data category by data category (upper layer). As a result, according to the information analysis supporting apparatus 2 of the second embodiment, when multiple meaning types are extracted from a data item name, it is possible for the analysis template retrieving part 50 to determine which meaning type is proper.

For example, when data item names include “date” and “failure details,” it is not possible to determine from “date” alone whether “date” means “trouble occurrence date” of “sales date.” In this case, however, if “trouble details” and “trouble report” of the upper level alone are extracted from “failure details,” it is estimated that a meaning type corresponding to “date” is “trouble occurrence date” belonging to “trouble report.” Thus, the analysis template retrieval part 53 of this embodiment refines search with respect to a data item name for which multiple meaning types are extracted based on a meaning type of the upper level extracted from another data item name.

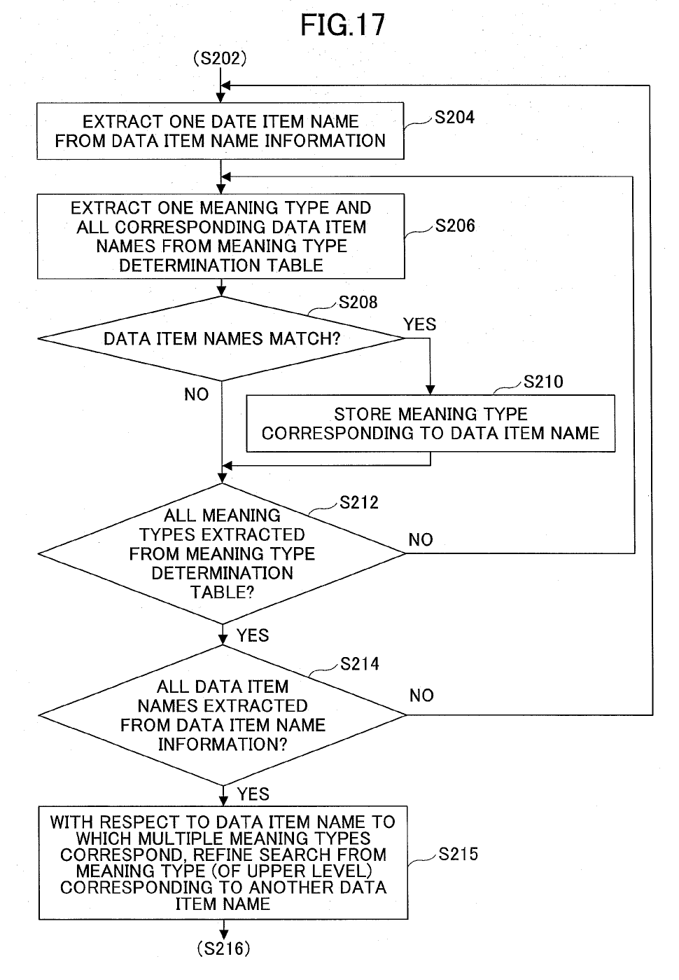

FIG. 17 is a flowchart illustrating part of a flow of a process that the analysis template retrieving part 50 executes using the meaning type determination table 42 having the above-described structure (FIG. 16). Because the process of FIG. 9 and FIG. 11 is common to the first embodiment and the second embodiment, a description is given below of a process corresponding to FIG. 10.

Referring to FIG. 17 as well as FIG. 3, first, at step S204, the analysis template retrieval part 53 of the second embodiment extracts one data item name from the data item name information 56.

Next, at step S 206, the analysis template retrieval part 53 extracts one meaning type and all data item names corresponding to the one meaning type from the meaning type determination table 42.

Next, at step S208, the analysis template retrieval part 53 determines whether the data item name extracted at step S204 matches one of the data item names extracted at step S206. The analysis template retrieval part 53 may determine that there is a “match” only when the data item names completely match or may determine that there is a “match” when the data item names partially match. A partial match between data item names is allowable because, for example, when “year, month and day of purchase” is stored in the meaning type determination table 42, no substantial problem is caused by determining that “month and day of purchase” matches “year, month and day of purchase.” In the case of allowing a partial match, the analysis template retrieval part 53 may, for example, give weight to each word constituting a data item name in advance and determine whether a difference is within an allowable range.

If the data item name extracted at step S204 matches one of the data item names extracted at step S206 (YES at step S208), at step S210, the analysis template retrieval part 53 stores a meaning type corresponding to the data item name in, for example, the memory unit 18, and the process proceeds to step S212.

If the data item name extracted at step S204 does not match any of the data item names extracted at step S206 (NO at step S208), the process proceeds to step S212.

At step S212, the analysis template retrieval part 53 determines whether all meaning types and all corresponding data item names have been extracted from the meaning type determination table 42. If all meaning types and all corresponding data item names have not been extracted from the meaning type determination table 42 (NO at step S212), the process returns to step S206 and the analysis template retrieval part 53 extracts the next meaning type (and all corresponding data item names).

If all meaning types and all corresponding data item names have been extracted from the meaning type determination table 42 (YES at step S212), at step S214, the analysis template retrieval part 53 determines whether all data item names have been extracted from the data item name information 56. If all data item names have not been extracted from the data item name information 56 (NO at step S214), the process returns to step S204, and the analysis template retrieval part 53 extracts the next data item name.

If all data item names have been extracted from the data item name information 56 (YES at step S214), at step S215, with respect to each data item name to which multiple meaning types corresponds, the analysis template retrieval part 53 refines search based on a meaning type (of the upper level) corresponding to another data item name. Then, at step S216 (FIG. 9), the analysis template retrieval part 53 executes a process.

By this process, an appropriate meaning type is extracted, so that appropriate template information is extracted. As a result, it is possible for the information analysis supporting apparatus 2 of the second embodiment to let a user who performs an analysis to select a more appropriate analysis process in accordance with the contents of analysis object data even when the user does not possess a high level of knowledge about methods of analysis.

In the above-described embodiments, for example, the meaning type determination table 42 may be described as “first data,” the analysis template correspondence table 43 and the analysis template information 44 may be described as “second data,” and the analysis template retrieving part 50 may be described as a “control part.”

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

Embodiments of the present invention may be used in, for example, a computer manufacturing industry, a computer software industry, and a computer service industry.

What is claimed is:

1. An information analysis supporting apparatus, comprising:
a computer processor; and
a storage part that stores
first data correlating data item names of analysis object data and standardized data item names;
second data correlating the standardized data item names and information related to analysis processes,
wherein the storage part stores instructions that, when executed by the computer processor, cause the information analysis supporting apparatus to
search, in response to inputting of the analysis object data, the first data using the data item names of the input analysis object data and extract the standardized data item names;
search the second data using the extracted standardized data item names and extract the information related to the analysis processes; and
cause a presentation part to present the extracted information related to the analysis processes.

2. The information analysis supporting apparatus as claimed in claim 1, wherein the storage part further stores instructions that, when executed by the computer processor, cause the information analysis supporting apparatus to, when the standardized data item names extracted by searching the first data partially match the standardized item names correlated with the information related to the analysis processes, cause the presentation part to present the information related to the analysis processes whose correlated standardized item names are partially matched, and information on one or more of the standardized item names correlated with the information related to the analysis processes that are not included in the extracted standardized data item names.

3. The information analysis supporting apparatus as claimed in claim 2, wherein the storage part further stores instructions that, when executed by the computer processor, cause the information analysis supporting apparatus to, cause the presentation part to present the extracted standardized data item names and the one or more of the standardized item names correlated with the information related to the analysis processes that are not included in the extracted standardized data item names in different manners.

4. The information analysis supporting apparatus as claimed in claim 1, wherein the storage part further stores instructions that, when executed by the computer processor, cause the information analysis supporting apparatus to, when two or more of the standardized data item names are extracted for one of the data item names of the input analysis object data by searching the first data, narrow down the extracted two or more of the standardized data item names based on a relationship with one of the standardized data item names extracted by searching the first data using another one of the data item names of the input analysis object data.

5. The information analysis supporting apparatus as claimed in claim 4,
wherein the first data are structured so that the standardized data item names are grouped data category by data category, and
wherein the storage part further stores instructions that, when executed by the computer processor, cause the information analysis supporting apparatus to, when the two or more of the standardized data item names are extracted for the one of the data item names of the input analysis object data by searching the first data, narrow down the extracted two or more of the standardized data item names based on a data group to which the one of the standardized data item names extracted by searching the first data using another one of the data item names of the input analysis object data belongs.

6. An information analysis supporting method, comprising:
in response to inputting of analysis object data, searching, by a computer processor, first data correlating data item names of the analysis object data and standardized data item names, using the data item names of the input analysis object data, and extracting, by the computer processor, the standardized data item names;
searching, by the computer processor, second data correlating the standardized data item names and information related to analysis processes, using the extracted standardized data item names, and extracting, by the computer processor, the information related to the analysis processes; and
causing, by the computer processor, a presentation part to present the extracted information related to the analysis processes.

7. The information analysis supporting method as claimed in claim 6, further comprising:
when the standardized data item names extracted by searching the first data partially match the standardized item names correlated with the information related to the analysis processes in said searching the second data and extracting the information related to the analysis processes, causing, by the computer processor, the presentation part to present the information related to the analysis processes whose correlated standardized item names are partially matched, and information on one or more of the standardized item names correlated with the information related to the analysis processes that are not included in the extracted standardized data item names.

8. The information analysis supporting method as claimed in claim 7, further comprising:
causing, by the computer processor, the presentation part to present the extracted standardized data item names and the one or more of the standardized item names correlated with the information related to the analysis processes that are not included in the extracted standardized data item names in different manners.

9. The information analysis supporting method as claimed in claim 6, further comprising:
when two or more of the standardized data item names are extracted for one of the data item names of the input analysis object data by searching the first data in said searching the first data and extracting the standardized data item names, narrowing down, by the computer processor, the extracted two or more of the standardized data item names based on a relationship with one of the standardized data item names extracted by searching the first data using another one of the data item names of the input analysis object data.

10. The information analysis supporting method as claimed in claim 9,
wherein the first data are structured so that the standardized data item names are grouped data category by data category, and
wherein the information analysis supporting method further comprises,
when the two or more of the standardized data item names are extracted for the one of the data item names of the input analysis object data by searching the first data, narrowing down, by the computer processor, the extracted two or more of the standardized data item names based on a data group to which the one of the standardized data item names extracted by searching the first data using another one of the data item names of the input analysis object data belongs.

11. A non-transitory computer-readable storage medium having stored therein a program for causing a computer to execute an information analysis supporting process comprising:
in response to inputting of analysis object data, searching first data correlating data item names of the analysis object data and standardized data item names, using the data item names of the input analysis object data, and extracting the standardized data item names;
searching second data correlating the standardized data item names and information related to analysis processes, using the extracted standardized data item names, and extracting the information related to the analysis processes; and
causing a presentation part to present the extracted information related to the analysis processes.

12. The non-transitory computer-readable storage medium as claimed in claim 11, wherein the information analysis supporting process further comprises,
when the standardized data item names extracted by searching the first data partially match the standardized item names correlated with the information related to the analysis processes in said searching the second data and extracting the information related to the analysis processes, causing the presentation part to present the information related to the analysis processes whose correlated standardized item names are partially matched, and information on one or more of the standardized item names correlated with the information related to the analysis processes that are not included in the extracted standardized data item names.

13. The non-transitory computer-readable storage medium as claimed in claim 12, wherein the information analysis supporting process further comprises
causing the presentation part to present the extracted standardized data item names and the one or more of the standardized item names correlated with the information related to the analysis processes that are not included in the extracted standardized data item names in different manners.

14. The non-transitory computer-readable storage medium as claimed in claim 11, wherein the information analysis supporting process further comprises,
when two or more of the standardized data item names are extracted for one of the data item names of the input analysis object data by searching the first data in said searching the first data and extracting the standardized data item names, narrowing down the extracted two or more of the standardized data item names based on a relationship with one of the standardized data item names extracted by searching the first data using another one of the data item names of the input analysis object data.

15. The non-transitory computer-readable storage medium as claimed in claim 14,
wherein the first data are structured so that the standardized data item names are grouped data category by data category, and
wherein the information analysis supporting process further comprises,
when the two or more of the standardized data item names are extracted for the one of the data item names of the input analysis object data by searching the first data, narrowing down the extracted two or more of the standardized data item names based on a data group to which the one of the standardized data item names extracted by searching the first data using another one of the data item names of the input analysis object data belongs.
